(19) United States
(12) Patent Application Publication
(10) Pub. No.: US 2014/0058928 A1
(43) Pub. Date: Feb. 27, 2014

(54) Mobile Money Transfer

(71) Applicant: Vodafone IP Licensing Limited, Berkshire (GB)

(72) Inventors: Peter CORNFORTH, Berkshire (GB); Jason DOWNING, Berkshire (GB); Gregory REEVE, Berkshire (GB)

(73) Assignee: Vodafone IP Licensing Limited, Berkshire (GB)

(21) Appl. No.: 13/946,559

(22) Filed: Jul. 19, 2013

(30) Foreign Application Priority Data
Jul. 20, 2012 (GB) 1212917.7

(51) Int. Cl. G06Q 20/32

(52) U.S. Cl. CPC G06Q 20/3223
USPC 705/39

(57) ABSTRACT

Method and system method for transferring funds in a mobile telephone based money transfer system comprising receiving a request for an amount of electronic funds. Debiting the amount of funds from the mobile telephone based money transfer system account, wherein the account is allowed to go or remain overdrawn following the debit.

### FIELD OF THE INVENTION

The present invention relates to a system and method transferring funds in a mobile telephone based money transfer system and in particular improving liquidity to facilitate such fund transfers.

### BACKGROUND OF THE INVENTION

Money transfer systems, especially within emerging markets, may be run through a network of third party agents, which are not usually managed centrally. Ensuring that these agents have available electronic or e-money and cash to serve customers can be an on-going problem. Management of the agent network is an overhead for the Operator providing the service and therefore increases cost. Improvement in agent management can both provide better customer experience for a critical aspect of the service (depositing and withdrawing cash from a mobile account) and reduce the overheads of the operator who is running the service.

For example, when an agent has to process a large number of transactions that deposit cash with agent to provide e-money to be used in the mobile telephone based electronic money system then the agent can quickly run out of e-money (i.e. balance on their account within the system). The agent must then purchase further e-money funds from an operator, bank or intermediary in order to continue servicing customers. The Agent may use their received cash funds to do this but this can require time-consuming physical cash handling involving increased security risks. This system and associated problem is described in more detail in The Economist, 10 Jun. 2010 “Out of Thin Air: The behind-the-scenes logistics of Kenya's mobile-money miracle” (http://www.economist.com/node/1639635). This can also require the agent to refuse transaction requests in the meantime reducing confidence in the system.

Existing systems involve the management of the agent network through a series of reports which specify if electronic money held within an agent account is either low or high. When there appears to be a problem with liquidity, a person working for the Operator will phone the agent or owner of the agent (their Head Office) to prompt them to resolve the situation. The following drawbacks include:
Management cost overhead on the Operator providing the service
Time delay for the Agent resolving the low/high e-money float issue
Due to discussion with Operator
Due to manual re-allocation of funds (if internal)
Due to reconciliation of funds from an external source (bank account) into the e-money system
Possibility of missing agents liquidity issues due to workload.

Therefore, there is required a system and method that overcomes these problems.

### SUMMARY OF THE INVENTION

Against this background and in accordance with a first aspect there is provided a method of transferring funds in a mobile telephone based money transfer system comprising the steps of:

receiving a request for an amount of electronic funds; and

debiting the amount of funds from a mobile telephone based money transfer system account, wherein the account is allowed to go or remain overdrawn following the debit. In other words, electronic funds are provided when required even though this will result in a negative balance. Therefore, requests for electronic funds may be met even when there are not enough available funds in the account. Reconciliation of the account may be carried out at a later time or date. There may also be a temporary imbalance in the total amount of electronic money in circulation and the total funds held as a reserve.

A mobile telephone based money transfer system account is an account within a mobile based money transfer system. The account (i.e. for each user) is not associated with a bank account, current account, credit card account, debit card account, pre-paid card issued by a financial institution or another type account within a financial institution. In other words, each user of the mobile telephone based money transfer system does not require or need to have access to a bank account or similar account to hold, transfer or process funds. Instead, the funds remain within the mobile based money transfer system unless they are exchanged for goods and services or withdrawn, usually as cash from an agent. Therefore, the mobile telephone based money transfer system does not require branches or an ATM network. Typically, there will be no transaction fee for fund transfers within the system.

Preferably, the method of may further comprise the step of determining if the request for the amount of electronic funds may be met without causing the account to become overdrawn by a predetermined upper overdraft limit, before the debiting step. This places safeguards on the system and limits risk and exposure.

Optionally, the method may further comprise the step of determining if the requested amount is greater than a predetermined upper transaction limit, before the debiting step. This prevents individual transactions from using a large proportion of available credit and so preventing further transactions from occurring.

Preferably, the method may further comprise the step of crediting the account with funds or electronic money sufficient to bring the account into credit or reduce the overdraft. This provides later reconciliation of cash and electronic money.

Preferably, the crediting step may occur after two or more debiting steps have completed. Therefore, transactions may continue even though the account is or remains overdrawn.

Optionally, the crediting step may occur at the end of a predetermined period. Therefore, transactions may continue even though the account is or remains overdrawn for a known and predictable or configurable period.

Optionally, the predetermined period may be daily, weekly or monthly. Other periods may be used or the period may be different each time.

Preferably, the method may further comprise the step of receiving cash with the request for electronic funds. The electronic funds may also be exchanged for goods or services instead of cash. However, typically an individual will exchange their cash for electronic funds provided by an agent or other retail entity.

Preferably, the request may be received from a cellular telephone.

According to a second aspect, there is provided a system for transferring funds in a mobile telephone based money transfer system comprising logic configured to:

receive a request for an amount of electronic funds; and

debit the amount of funds from a mobile telephone based money transfer system account, wherein the account is allowed to go or remain overdrawn following the debit.

Preferably, the system may further comprise:

a cellular interface configured to communicate with the mobile telephone based money transfer system. The cellular interface may be apparatus to communicate with a mobile network including mobile base stations.

Optionally, the mobile telephone based money transfer system may be M-Pesa. Other mobile telephone based money transfer systems may be used.

The methods described above may be implemented as a computer program comprising program instructions to operate a computer. The computer program may be stored on a computer-readable medium or sent as a signal.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of a method of transferring funds in a mobile telephone based money transfer system; and

FIG. 2 shows a schematic diagram of a mobile telephone based money transfer system used to implement the method of FIG. 1.

It should be noted that the figures are illustrated for simplicity and are not necessarily drawn to scale.

### DETAILED DESCRIPTION OF THE PREFERRED EMBODIMENTS

Cell phone based money transfer systems such as M-Pesa for example, provide a facility for transferring funds between mobile users. Cash may be exchanged for electronic money, which may be sent to family and friends, to pay bills or to purchase mobile airtime, for example. Such systems are designed to work on limited functionality mobile handsets using an installed SIM toolkit (STK) to provide additional menus dedicated to funds transfer, Unstructured Supplementary Service Data (USSD) sessions or interactive voice response (IVR) systems. SMS messages may be used to confirm to a sender and a receiver that an amount has been transferred following a transaction or payment. Cash may be redeemed or exchanged for electronic money (or “e-money”) at outlets, which may be grocery stores or airtime resellers, for example.

An example of such a system is described at: http://www.vodacom.co.za/personal/services/m-pesa/aboutm-pesa

Such money transfer systems are typically in use in countries with a limited banking infrastructure, where the population may not have access to basic financial services. Such systems are gaining popularity with millions of transactions occurring daily.

Depending on regulations there are a number of different business models for running mobile money transfer systems. In many markets a mobile operator partners with a financial institution to enable licensees to operate. Different roles and responsibilities result from both the combination of electronic money regulation and differing business relationships. The practical result of this relationship is that the financial institution is usually responsible for holding the funds that are in circulation within the money transfer system.

Money transfer systems use a network of independent Third party agents to manage cash-in and out of the system. The scale and management of these agents is important to ensure that the customer experience is good. The breadth of the agent network enables access to the service, however as agents are usually third parties and not centrally managed, ensuring that they remain liquid (financially) can be a problem. For example where an Operator manages the service, agents may be centrally owned, but more likely are part of the airtime distribution network which is managed by third parties. As such the only clear motivation for the third party agent to remain liquid is a fully operational and profitable service.

There are two main types of liquidity which need to be managed within an e-money system—cash and electronic funds. Cash liquidity needs to be managed physically and can be done so using existing infrastructure. If it is not managed, customers cannot withdrawal (cash) from the system. E-money or e-float liquidity can leverage relationships with other organisations, including distributors and financial institutions. If this is not managed then customers cannot deposit cash into the system. Inability to manage liquidity removes trust in the service and decreases the value of the service.

Funds may be automatically transferred from a financial system into the e-money system. This may be completed through an appropriate interface between the e-money system and the financial system. For example, e-money may be automatically created or allocated from internal accounts with settlement at a later point. This interface enables the agent to use e-money without pre-funding, removing the problem of e-money liquidity within system.

Automatic transfers may be triggered upon request of a deposit transaction from a customer. Depending on settlement criteria, e-money may be credited to the agent's wallet or account through withdrawal transactions or may be credited from a financial (real money) account.

To ensure effective communication between the two systems, rules based on transaction amount limits may be applied. These may control when queries will be sent to the bank. For example, queries may be sent when:
Transactions are over a certain transaction threshold
Accumulated transactions are over a certain threshold

This provides an improved experience by improving the speed of transaction processing. For example, through the extension of a rolling line of credit, small value transactions may not be passed to the financial institution for checking and with the overall outstanding amount settled at the end of the day or other predetermined period.

Such a system enables mobile money transfer systems, which initially emerge to serve the financially excluded, to be integrated into financial institutions acting as an extended financial network in addition to their traditional branch network.

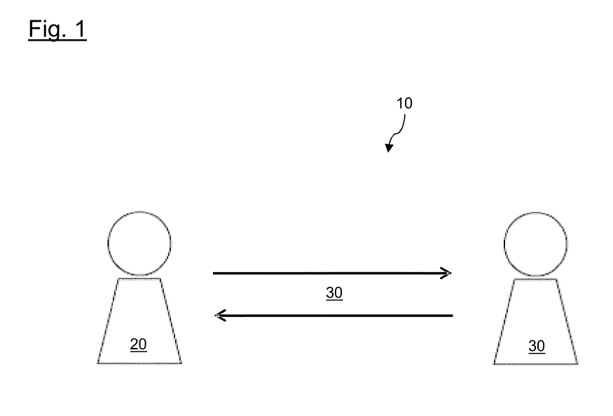

FIG. 1 shows a schematic diagram of a method 10 for transferring funds in a mobile telephone based money transfer system. An agent 20 holds an account within the system and the account may have a balance of electronic funds. The agent may receive cash, goods or services and in response provide electronic funds from their account to the customer 30. Typically, the customer 30 may wish to exchange (deposit) cash with the agent 20 and in return receive electronic funds. The customer 30 may have their own account within the same mobile telephone based money transfer system and the electronic funds may be credited to the customer account when they are debited from the agent account. Similarly, reverse transactions may occur where customer 30 takes cash from the Agent following a transfer of electronic funds from the customer's account to the Agent's account, minus any commission or charges.

In meeting a request from the customer 30, the agent's account may be allowed to go overdrawn. In other words, the Agent's account may be allowed to have a negative balance of electronic funds. Whilst this allows the transaction to complete, an imbalance may occur within the money transfer system. Usually, all or a set proportion of electronic funds within the system have a corresponding reserve amount held elsewhere. This may be held in a bank account, for example. Typically, the amount by which the agent's account is allowed to go overdrawn will be relatively small compared with the reserve amount held centrally. However, many agent accounts may exist and so their cumulative overdrafts may be large, albeit temporarily. Nevertheless, reconciliation of the agent's account may take place at a later time and perhaps after several transactions with different customers 30 have taken place. The reconciliation of the agent's account may take place by the agent depositing the received cash with a central institution such as a bank or authorised depository. Once this occurs, the agent's account may be credited with electronic funds to bring it into credit and no longer (or less) overdrawn. This reconciliation may take place at particular predetermined periods (perhaps daily, weekly or monthly, for example). The agent's account may also have a particular credit limit or threshold applied to the overdraft whereby further transactions are refused once that overdraft limit has been reached. Under these circumstances, reconciliation or refunding of the account may take place by depositing cash and crediting electronic funds to it.

Further restrictions may be placed on the transactions. For example, instead of or as well as determining whether an overall overdraft limit has been reached or will be reached by allowing the transaction, the size of individual transactions may be checked against predetermined thresholds or limits. In other words, individual transactions may not exceed a particular amount especially if this will result in the agent's account becoming or going further overdrawn. This prevents individual transactions or customers 30 from taking a large proportion or all of the available credit so that other customers' transactions may be refused.

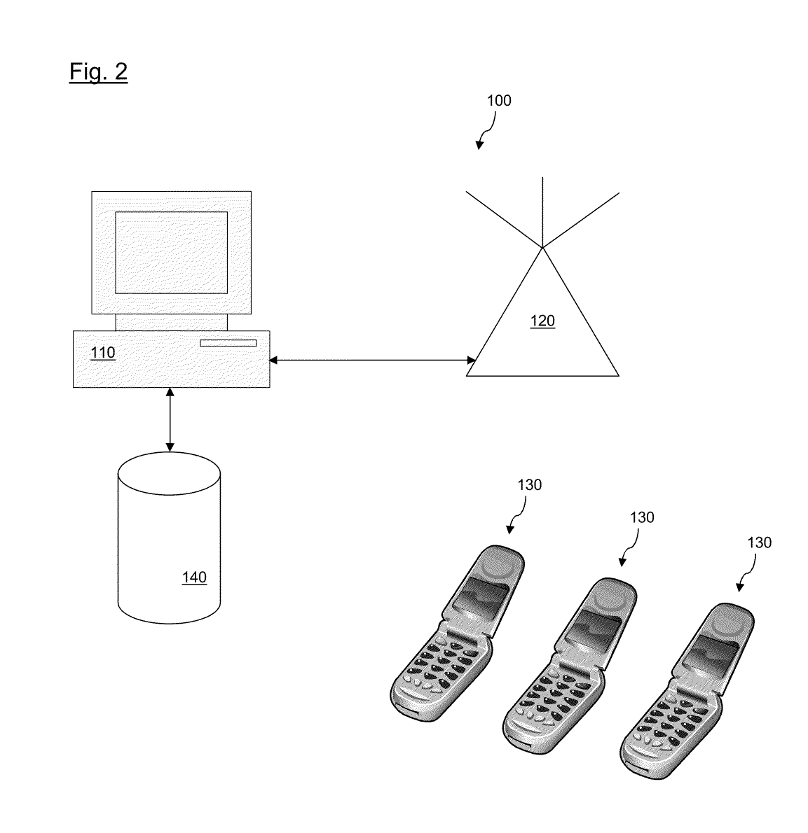

FIG. 2 shows a schematic diagram of a system 100 for implementing the method described with regards to FIG. 1. A server 110 may administer one or more accounts (either or both agent 20 or customer 30). The details of these accounts may be stored in one or more databases 140. The transaction described with reference to FIG. 1 may be initiated by mobile telephones 130. Both the customer 30 and/the agent 20 may use such a mobile telephone 130 to provide details and accept or refuse a transaction. The mobile telephones 130 may send and receive data relating to the transactions to one or more mobile base stations 120, which in turn communicate using interfaces with the server 110.

As will be appreciated by the skilled person, details of the above embodiment may be varied without departing from the scope of the present invention, as defined by the appended claims.

For example, other types of mobile telephones may be used such as for example, smart phones. Mobile apps may be used to carry out the transactions and so avoid the menu based systems used with more limited functionality handsets. Other notifications may be sent. Different mobile technologies may be utilised.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method of transferring funds in a mobile telephone based money transfer system comprising the steps of:
receiving a request for an amount of electronic funds; and
debiting the amount of funds from a mobile telephone based money transfer system account, wherein the account is allowed to go or remain overdrawn following the debit.

2. The method of claim 1 further comprising the step of determining if the request for the amount of electronic funds may be met without causing the account to become overdrawn by a predetermined upper overdraft limit, before the debiting step.

3. The method of claim 1 further comprising the step of determining if the requested amount is greater than a predetermined upper transaction limit, before the debiting step.

4. The method claim 1 further comprising the step of crediting the account with funds sufficient to bring the account into credit or reduce the overdraft.

5. The method of claim 4, wherein the crediting step occurs after two or more debiting steps have completed.

6. The method of claim 4, wherein the crediting step occurs at the end of a predetermined period.

7. The method of claim 6, wherein the predetermined period is daily, weekly or monthly.

8. The method of claim 1 further comprising the step of receiving cash with the request for electronic funds.

9. The method of claim 1, wherein the request is received from a cellular telephone.

10. A system for transferring funds in a mobile telephone based money transfer system comprising logic configured to:
receive a request for an amount of electronic funds; and
debit the amount of funds from a mobile telephone based money transfer system account, wherein the account is allowed to go or remain overdrawn following the debit.

11. The system of claim 10 further comprising:
a cellular interface configured to communicate with the mobile telephone based money transfer system.

12. The system of claim 10, wherein the mobile telephone based money transfer system is M-Pesa.

13. A computer program comprising program instructions that, when executed on a computer cause the computer to perform the method of claim 1.

14. A computer-readable medium carrying a computer program according to claim 13.

15. A computer programmed to perform the method of claim 1.
